(19) United States
(12) Patent Application Publication
(10) Pub. No.: US 2025/0170607 A1
(43) Pub. Date: May 29, 2025

(54) Piercing Cap For a Chub

(71) Applicant: Ingersoll Products Inc., Ingersoll (CA)

(72) Inventor: Daniel Mckenzie, Kitchener (CA)

(73) Assignee: Ingersoll Products Inc., Ingersoll (CA)

(21) Appl. No.: 18/958,725

(22) Filed: Nov. 25, 2024

(51) Int. Cl. B05C 17/01

(52) U.S. Cl. CPC B05C 17/0143

(57) ABSTRACT

A cap for use with a sleeve that receives a chub having material to be expelled through the cap. The cap has a base with a lower face with a downwardly depending skirt for receiving in or about an end of the sleeve. The base and the skirt define a cap body having an open interior. A bore extends through the base. One or more downwardly depending barbs are positioned on the lower face and about the bore. The barbs pierce the end of the chub when the skirt is received in or about an end of the sleeve, the chub is received within a longitudinal passageway through the sleeve, and the chub is advanced toward the cap and against the barbs. The barbs encourage movement of a portion of the end surface of the chub away from the bore as the chub is forced against the barbs.

### FIELD

This invention relates generally to the field of soft walled packaging, tubes, or chubs that may be used to store and dispense a wide variety of different materials. In particular, the invention generally relates to a piercing cap for use in association with a chub that may contain caulking, silicone, adhesives, or other viscous or granular materials.

### BACKGROUND

Caulking, adhesives, silicone, drywall compound, spackle, plaster, adhesives, and other such materials can be sold in soft walled packaging, tubes, flexible casings, cartridges, and the like. Recently, manufacturers have begun to replace more traditional cylindrical tubes used within a standard caulking gun with thin-walled, flexible, casings or chubs containing such materials that are to be applied or dispensed. These casings or chubs commonly have both of their ends crimped or otherwise sealed. Such chubs can be advantageous from the perspective of potentially being less expensive to manufacture as they typically involve the use of less material. The use of less material can also make the chubs more environmentally friendly than traditional cylindrical tubes as they often represent a lower volume of waste to be disposed of or recycled.

Chubs in the nature as described above are commonly made from a thin pliable material (for example a plastic, polyolefin, foil, or similar material, or in some cases layers of materials). Their inherent flexibility and pliability typically require insertion of the chub into a rigid or semi-rigid sleeve when the contained material is to be dispensed using a caulking gun so that the chubs are prevented from buckling when compressed by the plunger of the caulking gun. In operation, a chub is inserted into a sleeve having a cap at one end and being open at the opposite end for receiving the plunger of a caulking gun. Once the contents of the chub have been expelled, the spent thin-walled chub, largely devoid of its contents, can be removed from the sleeve and replaced with a new chub filled with the desired material.

A difficulty experienced by an operator using such chubs lies in the manner in which the end of the chubs is “opened” for use and for dispensing material. Current means of opening chubs include cutting the chub's fastener, clip, or other means of closure at one end and/or piercing the chub with a knife. Both of such means can result in leakage of the contents of the chub and/or the need to clean cutting utensils, increasing labour requirements. There is thus a need for a cap for use in association with a sleeve that receives a chub, where the cap efficiently pierces or “opens” an enclosed end of a chub, while at the same time allows for a substantially or practically unrestricted flow of material from the chub, through the cap, and ultimately through an applicator when the chub is compressed within the sleeve through operation of the plunger of a caulking gun.

### SUMMARY

The invention provides a unique piercing cap for a chub as described herein.

In one embodiment the invention provides a cap for use with a sleeve that receives a chub filled with a material to be expelled from the chub through the cap and onto a surface, the cap comprising: a base having a lower face with a downwardly depending skirt extending from the lower face, the skirt configured for receiving in or about a leading end of the sleeve, the base and the skirt together defining a cap body having a generally open or hollow interior, a bore extending through the base and defining a passageway from the open or hollow interior through the base, and one or more downwardly depending barbs positioned on the lower face and situated about the bore, the barbs piercing an end surface of the chub when the skirt is received in or about the leading end of the sleeve and when the end surface of the chub is received within a longitudinally oriented passageway through the sleeve and advanced toward the cap and forced against the barbs, the barbs configured to encourage movement of a portion of the pierced end surface of the chub away from the bore as the chub is forced against the barbs.

In another embodiment the invention comprises a combination comprising the cap described immediately above and a sleeve, the skirt of the cap releasably securable in or about a leading end of the sleeve, the sleeve having a longitudinally oriented passageway extending therethrough, the passageway releasably receiving a chub therein.

In yet a further aspect there is provided a cap for use with a sleeve that receives a chub filled with a material to be expelled from the chub through the cap and onto a surface, the cap comprising: a base having a lower face with a downwardly depending skirt extending from the lower face, the skirt configured for receiving in or about a leading end of the sleeve, the base and the skirt together defining a cap body having a generally open or hollow interior, a bore extending through the base and defining a passageway from the open or hollow interior through the base, and one or more downwardly depending barbs positioned on the lower face and situated about the bore, the barbs piercing an end surface of the chub when the skirt is received in or about the leading end of the sleeve and when the end surface of the chub is received within a longitudinally oriented passageway through the sleeve and advanced toward the cap and forced against the barbs, the barbs configured to encourage movement of a portion of the pierced end surface of the chub away from the bore as the chub is forced against the barbs, wherein each barb includes a support web extending between the barb and the lower face of the base, the support web providing structural rigidity to the associated barb, the support web associated with a barb encouraging movement of a portion of the pierced end surface of the chub away from the bore as the chub is forced against the associated barb, and wherein a longitudinally oriented inner face of each barb is concave, defining at least part of a flow passageway encouraging the flow of material expelled from the chub through the bore.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a side perspective view of a rigid or semi-rigid sleeve having secured thereto a cap in accordance with an embodiment of the invention.

FIG. 2 is an exploded view of the sleeve and cap of FIG. 1 showing a flexible chub to be inserted into the sleeve.

FIG. 3 is an upper side perspective view of the cap of the FIG. 1.

FIG. 4 is a side view of the cap of FIG. 1.

FIG. 5 is a bottom view of the cap of FIG. 1.

FIG. 6 is a lower perspective view of the cap of FIG. 1.

FIG. 7 is an alternate lower perspective view to that shown in FIG. 6.

FIG. 8 is a sectional view taken along the line 8-8 of FIG. 5.

FIG. 9 is a sectional view taken along the line 9-9 of a FIG. 5.

FIG. 10 is a sectional view taken along the line 10-10 of FIG. 5.

FIG. 11 is a longitudinal sectional view through the rigid or semi-rigid sleeve and cap shown in FIG. 1, prior to the leading end of the chub being pierced or “opened”.

FIG. 12 is a view subsequent to FIG. 11, wherein the chub has been advanced toward the cap with its leading edge pierced.

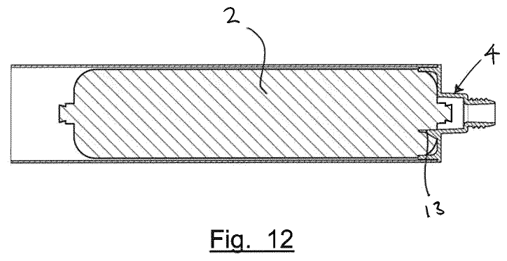

FIG. 13 is an enlarged view of the cap of FIG. 12, further demonstrating the piercing of the leading edge of the chub.

### DESCRIPTION

The present invention may be embodied in a number of different forms. The specification and drawings that follow describe and disclose some of the specific forms of the invention.

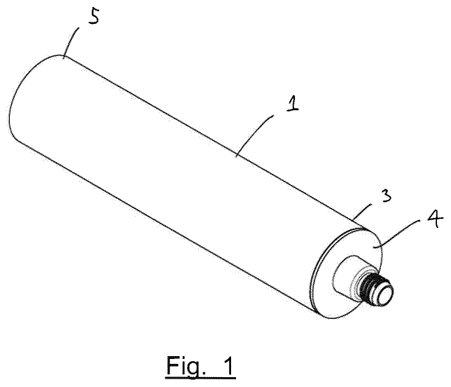

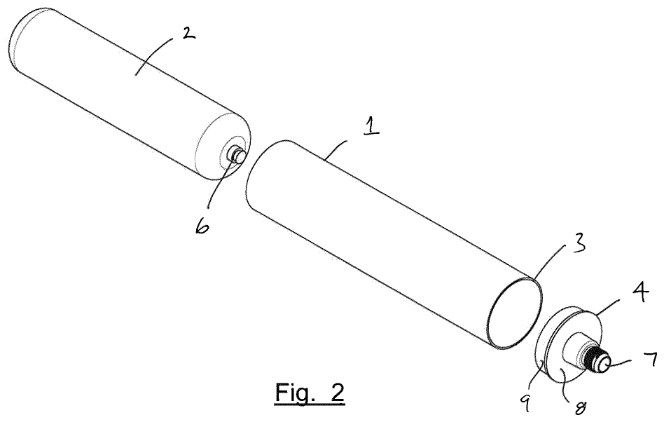

With specific reference to FIGS. 1 and 2, there is shown a somewhat standard rigid or semi-rigid hollow sleeve 1 dimensioned to receive therein a flexible chub 2. In practice, sleeve 1 will typically have secured thereto or be fitted with, at its leading end 3, a cap 4. Trailing end 5 of sleeve 1 will be open to permit the receipt of a plunger of a caulking gun. Commonly, chub 2 will be formed from a flexible or pliable material (which may comprise, but need not be limited to, plastics, polyolefin, foils, etc) filled with the material of choice and having each of its ends sealed or otherwise enclosed. Commonly, the ends of chub 2 are cinched closed through the use of a mechanical fastener or clip 6. As is common in the art, chub 2 may be inserted through trailing end 5 of sleeve 2 such that the plunger of a caulking gun can be subsequently inserted through trailing end 5, following which the application of pressure to the chub by the plunger of the caulking gun causes an expulsion of the material housed within the chub through cap 4, and also through an applicator if such is attached or otherwise secured to or about opening 7 in cap 4.

It will be appreciated that in order to expel the contents of chub 2 through cap 4, the leading end of the chub immediately adjacent to cap 4 will need to be pierced or otherwise “opened”. Others have proposed various mechanisms and manners to open the end of the chub, including using a knife or other cutting apparatus prior to the insertion of the chub into sleeve 1, and/or the incorporation of cutting blades on the interior surface of cap 4. A common problem faced when using caulking guns having such sleeve and cap structures is the tendency of the flexible material from which the chub is formed to block or partially block the flow of material from the chub through cap 4. In practice, the material from which the chub is formed can exhibit a tendency to bunch up within the interior of cap 4 once the chub has been “opened”, which at times can impede or restrict the flow of material through cap 4.

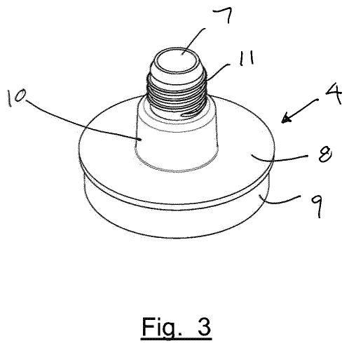

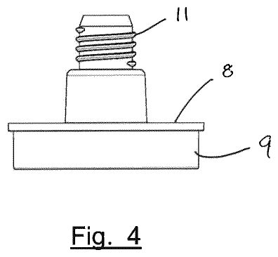

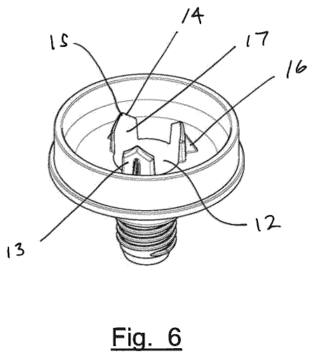

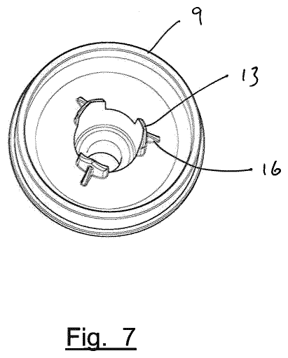

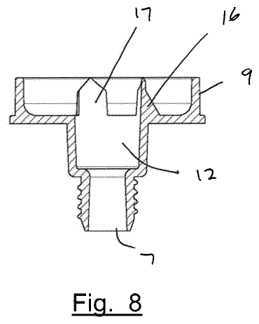

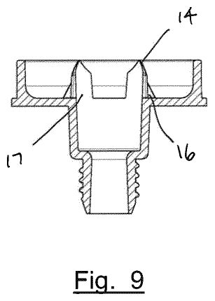

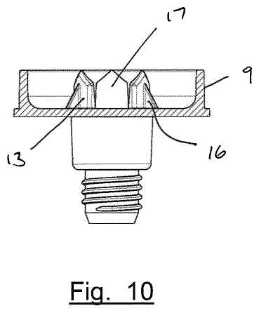

To address the inherent limitations with currently available sleeve and cap systems, in accordance with the present invention cap 4 presents a means to pierce or open the end of the chub and to also help to maintain open flow passageways to permit material from within the chub to be expelled through cap 4. The particular structure of cap 4 will now be discussed in detail with specific reference to FIGS. 3 through 10.

Cap 4 is comprised generally of an enclosed end or base 8 having a downwardly depending skirt 9 that is received in or about leading end 3 of sleeve 1. Enclosed end or base 8, together with skirt 9, define a cap body having a generally open or hollow interior. It will be appreciated from an understanding of the invention that skirt 9 and the manner of its securement to sleeve 1 may take a wide variety of different structures and configurations. For example, skirt 9 may be threaded and may be threadably received within or about the end of sleeve 1. Alternately, in some instances it may be desirable to glue or heat weld skirt 9 within the end of sleeve 1. In still other embodiments, skirt 9 may be received within or about the exterior of leading end 3 of sleeve 1 and held in place through the use of any one of a wide variety of mechanical fasteners or fastening mechanisms. In still other embodiments the skirt may be dimensioned to merely snugly fit inside or about the leading end of the sleeve, with the cap held in place during operation through its retainer within a caulking gun and the application of a compressive load by the action of the gun's plunger.

Within enclosed end 8 of cap 4 there will exist an opening or exit passageway 7 through which material can be expelled upon activation of the plunger of the caulking gun. Typically, opening 7 will be centrally located upon enclosed end 8, however, in other instances it could be offset. In the embodiment of cap 4 shown in the attached drawings, opening 7 is located at the outer end of a hollow conduit member 10 situated generally centrally on enclosed end 8. The outer end of conduit 10 may include threads 11 for threadably receiving an applicator that may be designed to expel material in a particular manner or for a particular purpose.

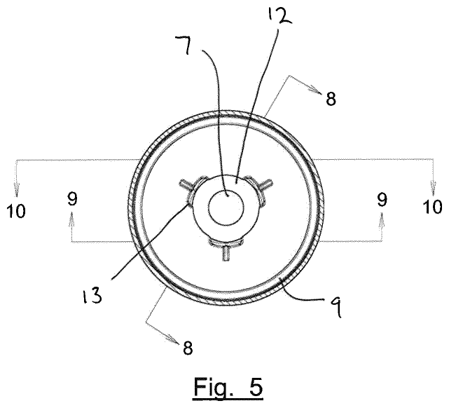

With specific reference to FIGS. 5 through 10, the interior structure of cap 4 will be described in further detail. The underside surface of enclosed end 8 may include a generally centrally located bore 12 that serves as a passageway for material to flow from below enclosed end 8 and within the open or hollow interior of cap 4, through conduit 10, and ultimately through opening 7. In the embodiment shown, bore 12 is of a generally circular nature in cross section. As will be appreciated from an understanding of the invention described below, bore 12 will preferably be dimensioned so as to receive and accommodate clip 6 when chub 2 is compressed within sleeve 1. Situated about bore 12, and on the lower face of enclosed end or base 8, are one or more downwardly extending (ie. in the same direction that skirt 9 depends from enclosed end or base 8) barbs 13 that may have sharpened side edges 14. In an embodiment of the invention, barbs 13 may end in pointed tips 15. In FIGS. 5 through 10, three such barbs are depicted, generally equally spaced about the circumference of bore 12. In other embodiments other numbers of barbs could be utilized. Further, each barb 13 may include a support web 16 intersecting its radially outward surface and extending to the inside surface of enclosed end 8. In the embodiment of FIGS. 5 through 10, support webs 16 are shown as generally triangular shaped structures. Webs 16 serve to provide additional rigidity to barbs 13 and to help prevent a bending or breakage of the barbs during use.

From an understanding of the invention, including the description that follows, it will be appreciated that barbs 13, in conjunction with support webs 16, serve as a means to pierce or “open” the leading end of chub 2 when the chub is received within sleeve 1 and compressed toward cap 4 by the plunger of a caulking gun. Further, the shape and structure of barbs 13 and support webs 16 aid in helping to direct the flexible or pliable material of the leading end of chub 2 in a radially outward manner as the chub is compressed into cap 4 and the leading end of the chub is pierced. The described barb structure encourages loose chub material that results from a piercing of the end of the chub to be directed radially outward within cap 4 and away from bore 12. In addition, the establishment of dedicated flow paths are encouraged, aiding in the flow of material from inside the chub, through the pierced leading end of the chub, into and through bore 12, and ultimately out through opening 7.

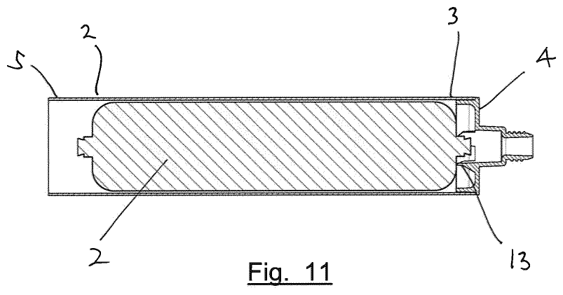

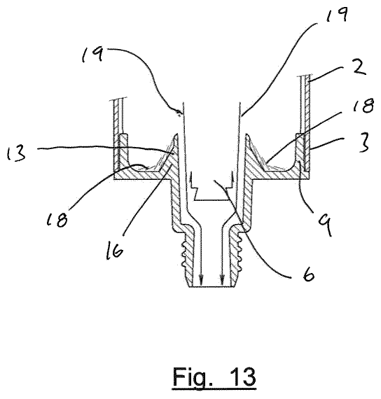

In application, as a chub is inserted into sleeve 1 and advanced toward cap 4 the leading end of the chub will initially contact barbs 13 (see FIG. 11). Thereafter, as additional compressive force is applied to the rearward end of the chub, the leading end of the chub is forced into barbs 13 which pierce the end of the chub causing a cutting or tearing of the chub material to expose the chub's contents. The sharpened and pointed nature of barbs 13 assists in easily and cleanly forming “openings” in the leading end of the chub. Further, as the chub is advanced toward cap 4 the material from which the chub casing is formed that has been cut by barbs 13 will tend to be driven along the angular surface formed by support webs 16 and will tend to accumulate in an area that is radially outward of barbs 13, and away from bore 12. In an embodiment of the invention barbs 13 have an arcuate or concave interior, longitudinally oriented, face or surface 17. The arcuate or concave interior faces or surfaces of barbs 13 help to form or define flow passageways or a flow passageway along the arcuate or concave surfaces (see arrows 19 in FIG. 13). The arcuate or concave faces or surfaces of barbs 13 assist in creating dedicated flow passageways or a dedicated flow passageway for material that is expelled from chub 2 and into or through bore 12 (see arrows in FIG. 13). Further, support webs 16 not only add rigidity to the barbs to help prevent bending or breakage during operation, but also help to provide a ramped or angled surface against which the flexible chub material is compressed in order to help drive the material in an outward direction and away from bore 12 (see FIG. 13) as the chub is advanced and the chub material or casing pierced and put.

It is to be understood that what has been described are the preferred embodiments of the invention. The scope of the claims should not be limited by the preferred embodiments set forth above, but should be given the broadest interpretation consistent with the description as a whole.

1. A cap for use with a sleeve that receives a chub filled with a material to be expelled from the chub through the cap and onto a surface, the cap comprising:
a base having a lower face with a downwardly depending skirt extending from the lower face, the skirt configured for receiving in or about a leading end of the sleeve, the base and the skirt together defining a cap body having a generally open or hollow interior,
a bore extending through the base and defining a passageway from the open or hollow interior through the base, and
one or more downwardly depending barbs positioned on the lower face and situated about the bore, the barbs piercing an end surface of the chub when the skirt is received in or about the leading end of the sleeve and when the end surface of the chub is received within a longitudinally oriented passageway through the sleeve and advanced toward the cap and forced against the barbs, the barbs configured to encourage movement of a portion of the pierced end surface of the chub away from the bore as the chub is forced against the barbs.

2. The cap as claimed in claim 1 having at least three barbs, equally spaced about the bore on the lower face of the base.

3. The cap as claimed in claim 1 wherein each barb includes a pointed or sharpened tip.

4. The cap as claimed in claim 3 wherein the barbs include sharpened side edges.

5. The cap as claimed in claim 3 wherein each barb includes a support web extending between the barb and the lower face of the base, the support web providing structural rigidity to the associated barb.

6. The cap as claimed in claim 5 wherein the support web associated with a barb encourages movement of a portion of the pierced end surface of the chub away from the bore as the chub is forced against the associated barb.

7. The cap as claimed in claim 6 wherein the support webs are triangular shaped.

8. The cap as claimed in claim 1 wherein a longitudinally oriented inner face of each barb is concave, defining at least part of a flow passageway encouraging the flow of material expelled from the chub through the bore.

9. The cap as claimed in claim 5 wherein a longitudinally oriented inner face of each barb is concave, defining at least part of a flow passageway encouraging the flow of material expelled from the chub through the bore.

10. The cap as claimed in claim 1 wherein the skirt is releasably securable to the sleeve.

11. A combination comprising the cap of claim 1 and a sleeve, the skirt of the cap releasably securable in or about a leading end of the sleeve, the sleeve having a longitudinally oriented passageway extending therethrough, the passageway releasably receiving a chub therein.

12. The combination as claimed in claim 11 wherein each barb includes a support web extending between the barb and the lower face of the base, the support web providing structural rigidity to the associated barb.

13. The combination as claimed in claim 12 wherein the support web associated with a barb encourages movement of a portion of the pierced end surface of the chub away from the bore as the chub is forced against the associated barb.

14. The combination as claimed in claim 13 wherein a radially inner face of each barb is concave, defining at least part of a flow passageway encouraging the flow of material expelled from the chub through the bore.

15. A cap for use with a sleeve that receives a chub filled with a material to be expelled from the chub through the cap and onto a surface, the cap comprising:
a base having a lower face with a downwardly depending skirt extending from the lower face, the skirt configured for receiving in or about a leading end of the sleeve, the base and the skirt together defining a cap body having a generally open or hollow interior,
a bore extending through the base and defining a passageway from the open or hollow interior through the base, and
one or more downwardly depending barbs positioned on the lower face and situated about the bore, the barbs piercing an end surface of the chub when the skirt is received in or about the leading end of the sleeve and when the end surface of the chub is received within a longitudinally oriented passageway through the sleeve and advanced toward the cap and forced against the barbs, the barbs configured to encourage movement of a portion of the pierced end surface of the chub away from the bore as the chub is forced against the barbs,
wherein each barb includes a support web extending between the barb and the lower face of the base, the support web providing structural rigidity to the associated barb, the support web associated with a barb encouraging movement of a portion of the pierced end surface of the chub away from the bore as the chub is forced against the associated barb,
and wherein a longitudinally oriented inner face of each barb is concave, defining at least part of a flow passageway encouraging the flow of material expelled from the chub through the bore.
